(19) United States
(12) Patent Application Publication
(10) Pub. No.: US 2006/0130263 A1
(43) Pub. Date: Jun. 22, 2006

(54) Wiper coupler and wiper assembly incorporating same

(76) Inventor: Timothy J. Coughlin, Holly, MI (US)

Correspondence Address: BLISS MCGLYNN, P.C., 2075 WEST BIG BEAVER ROAD, SUITE 600, TROY, MI, 48084, US

(21) Appl. No.: 11/016,597

(22) Filed: Dec. 17, 2004

(51) Int. Cl. B60S 1/40

(52) U.S. Cl. 15/250.32; 15/250.31

(57) ABSTRACT

The present invention relates to a wiper coupler for connecting a wiper blade assembly to a wiper arm including a pair of sidewalls with each sidewall including an aperture aligned with respect to the other. Each aperture is adapted to operatively receive a transversely extending pin of a wiper arm. The wiper coupler further includes a platform disposed between the sidewalls. The platform has a super-surface and a subsurface where the super-surface includes a rest portion adapted to operatively receive a portion of a wiper arm and the subsurface includes a pair of cantilevered beams depending therefrom and adjacent to the sidewalls. The cantilevered beams are adapted to operatively engage a portion of a wiper assembly.

### BACKGROUND OF THE INVENTION

1. Field of the Invention

The present invention relates, generally, to windshield wiper assemblies. More specifically, the present invention relates to a wiper coupler and windshield wiper assembly incorporating same for use in connecting the wiper assembly to the wiper arm of a vehicle.

2. Description of the Related Art

Conventional windshield wiper assemblies known in the related art include some type of wiper assembly mounted to an arm which, in turn, is mounted adjacent the windshield and pivotally driven to impart reciprocating motion to the wiper blade assembly across the windshield. A rubber wiping element is supported by the blade assembly and contacts the windshield across the surface to be wiped. The wiper element often incorporates one or more metal strips which act to reinforce the wiper element and facilitate wiping contact by the element across what is typically a curved glass surface. Generally, a wiper assembly may be classified into one of two categories commonly referred to as, “tournament-style” wiper assemblies and “beam-blade” wiper assemblies.

Tournament-style wiper assemblies include a superstructure having a primary lever carried by the arm, two or more secondary levers and a series of two or more tertiary levers. The primary lever is pivotally attached to the wiper arm by way of a coupler that is generally removable from both the wiper arm and the primary lever. The secondary levers are articulated to the primary lever at pivot points located at the opposed, lateral ends of the primary lever. Similarly, the tertiary levers are each articulated to a secondary lever at pivot points located at the opposed lateral ends of the secondary levers. The wiper element or blade is attached to the tertiary levers and contacts the surface to be wiped, which is generally a windshield. Often the blade of the tournament-style wiper assembly is removable from the tertiary levers for replacement convenience. An example of a tournament-style wiper assembly can be found in U.S. Pat. No. 6,026,537 issued to Hojnaki on Feb. 22, 2000 and assigned to Trico Products Corporation.

Beam-blade style wiper assemblies include a single elongated, homogeneous strip forming a spring backbone. The backbone is operatively coupled to the wiper arm by a fixed connecting formation at a central position. In a beam-blade style wiper assembly the reciprocally driven wiper arm applies a downward force and moves the blade assembly across the surface to be wiped, which is generally a windshield. The backbone is curved along a single plane which is the same plane of curvature as that defined by the windshield. A wiper element or blade is fixedly secured to the backbone. An example of a beam-blade style windshield wiper assembly can be found in U.S. Pat. No. 6,675,433 issued to Stewart, et al, on Jan. 13, 2004 and assigned to Trico Products Corporation.

While each style of wiper assembly has worked for its intended purpose, beam blade-style wiper assemblies are limited for use with a particular style of wiper arm, while tournament-style wiper assemblies may be employed in connection with a variety of wiper arm styles. Specifically, the coupler of a beam blade-style wiper assembly is designed solely for use with a single wiper arm style, while a coupler of a tournament-style wiper assembly may operatively couple the assembly to any number of wiper arm styles. As a result, replacement tournament-style wiper assemblies are widely available in the aftermarket while replacement beam blade-style wiper assemblies are often only available though automotive dealerships that sell vehicles utilizing that particular style of wiper arm. Furthermore, as a result of the fixed blade and fixed coupler of the beam blade-style wiper assembly, when the blade becomes worn the end user's only option is to replace the entire assembly. Conversely, the end user of a tournament-style wiper assembly may choose to replace the entire tournament-style wiper assembly or opt to replace only the blade portion of a tournament-style wiper assembly.

As a result of the limited aftermarket availability and fixed blade design, beam blade-style wiper assemblies are generally more expensive than tournament-style wiper assemblies. Accordingly, there is a need in the art for a coupler that operatively couples a tournaments-style wiper assembly to a wiper arm designed for a beam blade-style wiper assembly. In addition, there is a need in the art for a coupler that operatively engages a wiper arm designed for a beam blade-style wiper assembly and wiper assembly incorporating same having a replaceable blade.

### SUMMARY OF THE INVENTION

The present invention overcomes many limitations and disadvantages in the related art in wiper coupler, as well a wiper blade assembly replacement system incorporating same, for use in connecting a wiper blade assembly to a wiper arm. To this end, the wiper coupler of the present invention includes a pair of sidewalls with each sidewall including an aperture aligned with respect to the other. Each aperture is adapted to operatively receive a transversely extending pin of a wiper arm. The wiper coupler further includes a platform disposed between the sidewalls. The platform has a super-surface and a subsurface where the super-surface includes a rest portion adapted to operatively receive a portion of a wiper arm and the subsurface includes a pair of cantilevered beams depending therefrom and adjacent to the sidewalls. The cantilevered beams are adapted to operatively engage a portion of a wiper assembly.

The present invention further includes a wiper assembly for use in connection with a wiper arm having a transversely extending pin and a bent tab. The wiper assembly includes a superstructure adapted to facilitate movement of the wiper assembly across a surface to be wiped. The superstructure includes a primary lever and at least one secondary lever operatively engaged to the primary lever. The wiper assembly further includes a wiper element operatively supported by the superstructure and adapted to contact the surface to be wiped. The wiper assembly also includes a wiper coupler operatively mounted to the superstructure and adapted to releasably couple a wiper arm to the superstructure. The wiper coupler includes a pair of sidewalls with each sidewall including an aperture aligned with respect to the other and adapted to operatively receive a transversely extending pin of a wiper arm. The wiper coupler further includes a platform disposed between the sidewalls having a super-surface and a subsurface. The super-surface includes a rest portion adapted to operatively receive a portion of a wiper arm and the subsurface includes a pair of cantilevered beams depending therefrom and adjacent to the sidewalls. The cantilevered beams are adapted to operatively engage a portion of the superstructure.

Thus, one advantage of the present invention is that the wiper coupler operatively engages a tournament-style wiper blade assembly to a wiper arm originally adapted to operatively engage a beam blade wiper assembly.

Another advantage of the present invention is that the wiper coupler provides a tournament-style wiper blade assembly as a replacement option to beam blade wiper assemblies, thereby reducing costs associated with replacing a beam blade wiper assembly.

Still another advantage of the present invention is that it provides a wiper blade assembly system having a replaceable wiping element to reduce the costs associated with replacing a beam blade wiper blade assembly.

Yet another advantage of the present invention is that it provides a wiper blade assembly system incorporating a replaceable wiping element to be replaced by readily available wiping elements to simplify the task associated with replacing a beam blade wiper assembly.

Other objects, features and advantages of the present invention will be readily appreciated as the same becomes better understood after reading the subsequent description taken in connection with the accompanying drawings.

### BRIEF DESCRIPTION OF THE DRAWINGS

FIG. 1 is a partial perspective view of the front of an automotive vehicle having a pair of windshield wiper assemblies pivotally mounted for reciprocal movement across the windshield of the vehicle.

FIG. 2 is a side partial perspective view of the wiper coupler and wiper assembly in accordance with the present invention.

FIG. 3A is a bottom partial perspective view of the wiper coupler and wiper assembly in accordance with the present invention.

FIG. 3B is a top partial perspective view of the wiper coupler and wiper assembly in accordance with the present invention.

FIG. 4 is fragmentary view of a wiper arm, wiper coupler and wiper assembly in accordance with the present invention.

### DETAILED DESCRIPTION OF THE PREFERRED EMBODIMENT(S)

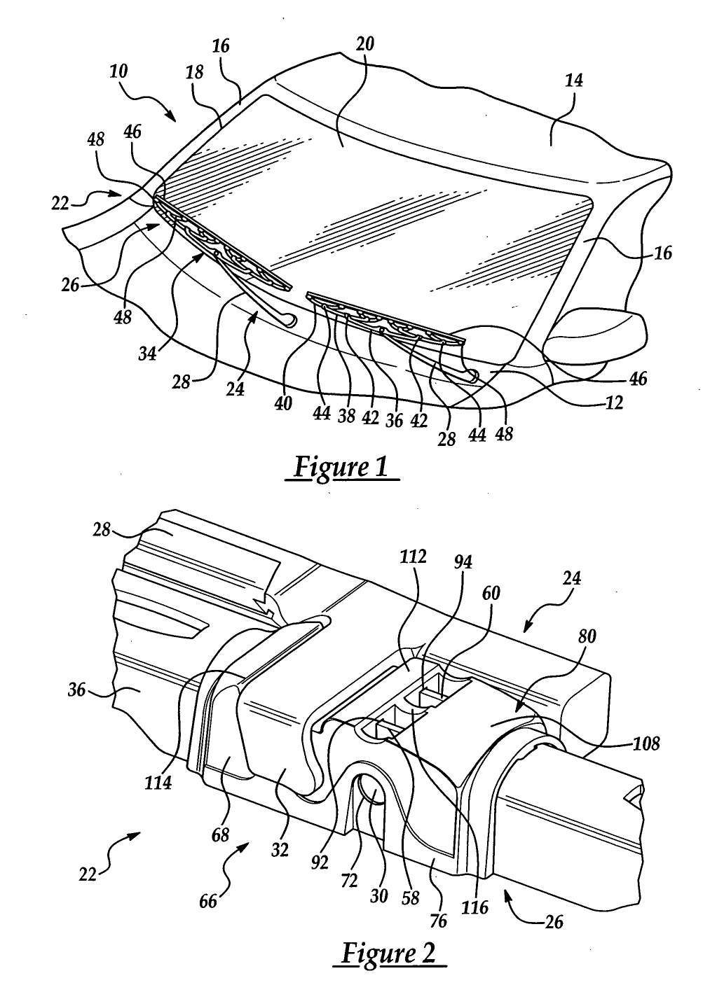

Referring now to the figures, where like numerals are used to designate like structure, a portion of a vehicle is schematically illustrated at 10 in FIG. 1. The vehicle includes a cowl 12, a roof 14, and a pair of laterally spaced front or “A” pillars 16 extending between the roof 14 and the cowl 12. The A-pillars 16, roof 14, and cowl 12 cooperate to define a generally rectangular opening 18 in which is supported a curved or “swept back” glass windshield 20.

A wiper system is generally indicated at 22 in FIG. 1 and is employed to clean the glass windshield 20. The wiper system 22 includes a wiper arm, generally indicated at 24 and a wiper assembly, generally indicated at 26. Those having ordinary skill in the art will appreciate that a wiper system 22 may include more than wiper arm 24 and more than one wiper assembly 26. By way of example and as indicated in FIG. 1, a wiper system 22 includes a pair of wiper arms 24 and wiper assemblies 26, which correspond to the driver and passenger side of the vehicle 10.

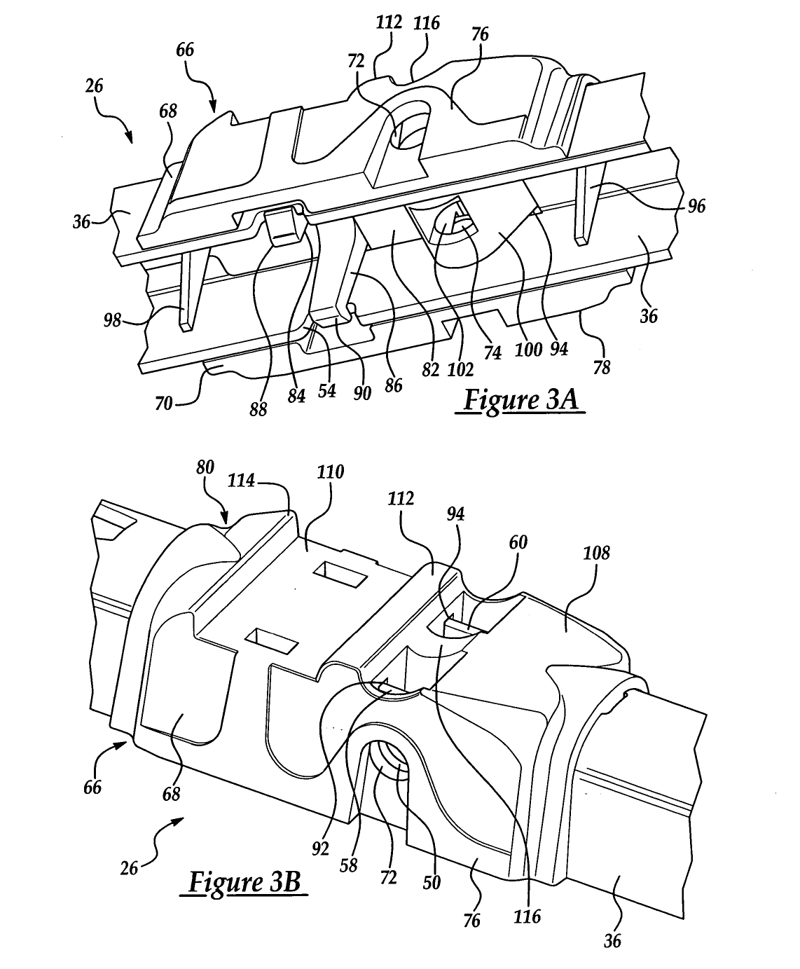

The wiper arm 24 includes an elongate body 28 and is pivotally attached at one end to an electrical motor (not shown) to power the wiper system 22 and move the wiper arm 24 across the surface to be wiped. Specifically, the wiper arm 24 is moved in an oscillating manner across the surface of the glass windshield 20. As shown in FIGS. 2-4, the wiper arm 24 further includes a pin 30 that extends transversely from the body 28 and a bent tab 32 that also extends transversely from the body 28 adjacent the pin 30. The pin 30 and bent tab 32 cooperate to attach the wiper arm 24 to a wiper assembly 26, as will be described in greater detail below. Those having ordinary skill in the art will appreciate that the wiper arm 24 may further include a biasing member (not shown), such as a spring, to provide a biasing force that facilitates contact between the wiper assembly 28 and the windshield 20 of the vehicle 10.

Further, those having ordinary skill in the art will appreciate the a wiper arm 24 including a transversely extending pin 30 and bent tab 32 is employed for use in connection with a beam blade style wiper assembly. However, as shown in FIG. 1, the wiper assembly 26 of the wiper system 22 includes a superstructure, generally indicated at 34. The superstructure 34 of the wiper assembly 26 may be commonly referred to as a “tournament” style superstructure as it includes a primary lever 36 and at least one secondary lever 38. Specifically, as shown in FIG. 1, the superstructure 34 includes two secondary levers 38 and a series of tertiary levers 40. The secondary levers 38 are articulated to the primary lever 36 at pivot points 42 located at the opposed, lateral ends of the primary lever 36. Likewise, the tertiary levers 40 are each articulated to a secondary lever 38 at pivot points 44 located at the opposed lateral ends of the secondary levers 38. However, those of ordinary skill in the art will appreciate that the superstructure 34 may take a number of different configurations without departing from the scope of the invention.

With continuing reference to FIG. 1, the wiper assembly 26 includes a wiper element 46 operatively supported by the superstructure 34. The tertiary levers 40 include claws 48 formed on the opposed distal ends which secure one end of the wiper element 46 to the superstructure 34 while the other end of the wiper element 34 is operable for wiping action against the glass windshield surface 20. The wiper element 46 may be constructed from any suitable material that imparts a flexible quality when cured, such as rubber, silicone, or a polymer. Further, given that the wiper element 46 is virtually in constant contact with the windshield 20, it will likely wear prior to the other components of the wiper assembly 26. Accordingly, the wiper element 46 is removably secured to the superstructure 34 in order that it may be replaced when worn. Moreover, while the wiper element 46 is shown operatively supported by the tertiary levers 40 of the superstructure 34, those having ordinary skill in the art will appreciate that the wiper element 46 may be operatively supported by any one of the levers closest to the surface to be wiped. By way of example, where tertiary levers 40 are not employed with the superstructure 34, the wiper element 46 may be operatively supported by one or more secondary levers 38.

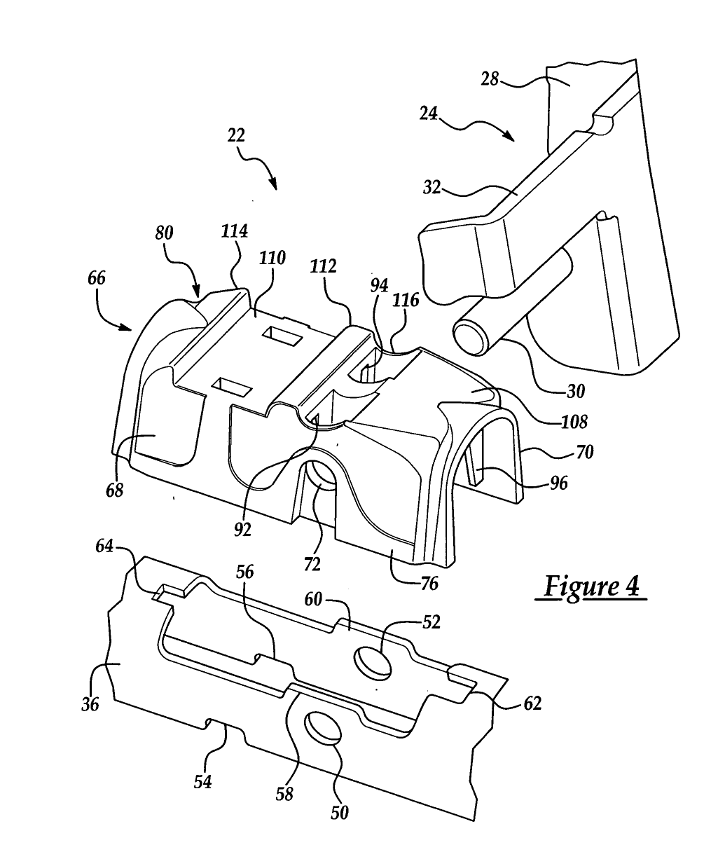

Referring to FIGS. 2-4, the primary lever 36 includes aligned bores 50 that are adapted to receive a portion of the transversely extending pin 30 of the wiper arm 24 when connected to the wiper assembly 26. Depending on the length of the transversely extending pin 30, the one or both of the aligned bores 50, 52 will operatively receive a portion of the pin 30. Further, the primary lever 36 includes additional structure to operatively engage a wiper coupler, as will be described in greater detail below. More specifically, and as best shown in FIG. 4, the primary lever 36 includes aligned notches 54, 56, shoulders 58, 60, and bays 62, 64, which will be more fully described during the discussion that follows with respect to the wiper coupler.

Referring to FIGS. 2-4, the wiper assembly further includes as wiper coupler generally indicated at 66. The wiper coupler 66 is operatively mounted to the superstructure 34 and releasably engages the wiper assembly 26 with the wiper arm 24. Specifically, the wiper coupler 66 interconnects the primary lever 36 of the superstructure 34 as well as the pin 30 and bent tab 32 of the wiper arm 24. The wiper coupler 66 includes a pair of sidewalls 68, 70. Each of the sidewalls 68, 70 include apertures 72, 74 aligned with respect to each other. The apertures 72, 74 are adapted to operatively engage a portion of the transversely extending pin 30 of the wiper arm 24. As further shown in FIGS. 2-4, the sidewalls 68, 70 also include at least one raised surface 76, 78 to provide additional support along the areas which may receive the highest amount of stress during operation of the wiper system 22. However, those having ordinary skill in the art will appreciate that the sidewalls 68, 70 may include more than one raised surface 76, 78 to accomplish a similar end.

The wiper coupler 66 further includes a platform, generally indicated at 80. The platform 80 is disposed between the sidewalls 68, 70 and includes a subsurface 82 having a pair of cantilevered beams 84, 86 depending therefrom adjacent to the sidewalls 68, 70. The cantilevered beams 84, 86 engage a portion of the wiper assembly 26, namely the superstructure 34. Each of the cantilevered beams 84, 86 include a flanged terminal end 88, 90. The flanged terminal ends 88, 90 engage the aligned notches 54, 56 of the primary lever 36 to facilitate operative engagement between the wiper coupler 66 and the portion of the primary lever 36 disposed between the cantilevered beams 84, 86 and the sidewalls 68, 70. In this manner, the relationship between the flanged terminal ends 88, 90 of the cantilevered beams 84, 86 and the aligned notches 54, 56 prevents vertical movement of the coupler 46 relative to the superstructure 34 during operational movement of the wiper system 22 across the windshield 20.

The subsurface 82 further includes aligned recesses 92, 94 adapted to receive the shoulders 58, 60 of the primary lever 36 and prevent linear movement of the wiper coupler 66 relative to the superstructure 34. To this end, the subsurface 82 further includes at least one leg 96 depending therefrom. As shown in FIG. 3A, in the preferred embodiment, the subsurface 82 includes two legs 96, 98 depending therefrom. The legs 96, 98 are operatively received by bays 62, 64 within the superstructure 34, namely within the primary lever 36 (FIG. 4). Accordingly, the number of bays 62, 64 within the primary lever 36 corresponds to the number of legs 96, 98 depending from the subsurface 82 of the platform 80. However, those having ordinary skill in the art will appreciate that the wiper coupler 66 may include any number of legs 96, 98 and the primary lever 36 will thus include a corresponding number of bays 62, 64. In either event, the relationship between the bays 62, 64 and shoulders 58, 60 of the primary lever 36 to the legs 96, 98 and recesses 92, 94 of the wiper coupler 66, respectively, serves to limit linear movement between the superstructure 34 and the wiper coupler 66 during operation of the wiper system 22.

As shown in FIG. 3A, the subsurface 82 further includes a housing 100. The housing 100 includes a passage 102 that is adapted to receive the transversely extending pin 30 of a wiper arm 24. The passage 102 of the housing 100 is aligned with the apertures 72, 74 in the sidewalls 68, 70 to cooperatively engage the pin 30 of the wiper arm 24. Further, the both the apertures 72, 74 and the housing passage 102 align with the bores 50, 52 of the primary lever 36 such that a portion of the pin 30 of the wiper arm 24 is received by both the wiper coupler 66 and the primary lever 36 when the wiper assembly 26 is connected to the wiper arm 24.

Referring once again to FIGS. 2-4, the platform 80 further includes a super-surface 108 having a rest portion 110 that is adapted to receive a portion of the bent tab 32 of the wiper arm 24. Specifically, when the wiper assembly 26 is connected to the wiper arm 24, the bent tab 32 straddles the wiper coupler 66 across the rest portion 110 and along the sidewall 68, while the elongate body 28 of the wiper arm 24 is juxtaposed adjacent the other sidewall 70 (FIG. 2). The super-surface 108 of the platform 80 further includes at least two ridges 112, 114 formed along opposite sides of the rest 110. The ridges 112, 114 serve to restrict lateral movement of the portion of the wiper arm 24 received by the rest 110, which may occur during operational movement of the wiper assembly 26 across the windshield 20.

The super-surface 108 further includes a groove 116 that extends parallel to the rest portion 110 to limit the range of movement of the wiper arm 24 during connection to the wiper assembly 26. Specifically, to install the wiper assembly 26 to the wiper arm 24, the wiper assembly 26 is initially positioned in a substantially perpendicular manner relative to the wiper arm 24. The groove 116 provides the maximum position in which the wiper assembly 26 may be placed relative to the bent tab 32 in order to properly connect the wiper assembly 26 to the wiper arm 24. With the wiper arm 24 in the correct position relative to the wiper assembly 26, as governed by the groove 116, the transversely extending pin 30 may be inserted through the aligned sidewall apertures 72, 74, primary lever bores 50, 52 and housing passage 102. The wiper assembly 26 is then rotated about the pin 30 until the bent tab 32 is received by the rest portion 110 of the wiper coupler 66. When correctly installed, the wiper assembly 26 is oriented parallel to the wiper arm 24, with a portion of the bent tab 32 straddled over the rest portion 110 and one sidewall 68 and a portion of the wiper arm body 28 adjacent the opposite sidewall 70. The raised surfaces 76, 78 of the sidewalls 68, 70 may also serve to provide an additional amount of friction between the wiper coupler 66 and the wiper arm 24 to maintain the connection between same in the installed position even when the wiper element 46 is not in contact with the windshield 20. Further, during replacement of the wiper element 46 or the entire wiper assembly 26, the groove 116 may also serve as a stop, indicating the proper amount of rotational travel of the wiper assembly 26 relative to the wiper arm 24 to provide sufficient clearance for removing the wiper assembly 26 from the wiper arm 24.

The wiper system 22 of the present invention provides a wiper coupler 66 that operatively connects a wiper assembly 26 having a tournament-style superstructure 34 to a wiper arm 24 having a transversely extending pin 30 and bent tab 32, which is conventionally adapted to operatively connect a beam blade style wiper assembly. Accordingly, the wiper system 22 of the present invention provides a wiper assembly 26 having a tournament-style superstructure 32 as a replacement option to beam blade wiper assemblies, thereby reducing costs associated with replacing a beam blade wiper assemblies. The wiper assembly 26 of the present invention includes a wiper coupler 66 that operatively connects tournament style superstructure wiper assembly 26 having a removable wiper element 46 to a wiper arm 24 conventionally adapted to operatively connect to a beam blade style wiper assembly. Accordingly, the removable wiper element 46 of the wiper assembly 26 of the present invention reduces costs associated with replacing beam blade wiper blade assemblies.

The invention has been described in an illustrative manner. It is to be understood that the terminology which has been used is intended to be in the nature of words of description rather than of limitation. Many modifications and variations of the invention are possible in light of the above teachings. Therefore, within the scope of the appended claims, the invention maybe practiced other than as specifically described.

What is claimed is:

1. A wiper coupler for use in connecting a wiper assembly to a wiper arm, said wiper coupler comprising:
a pair of sidewalls with each sidewall including an aperture aligned with respect to the other, each aperture adapted to operatively receive a transversely extending pin of a wiper arm; and
a platform disposed between said sidewalls having a super-surface and a subsurface, said super-surface including a rest portion adapted to operatively receive a portion of a wiper arm, said subsurface including a pair of cantilevered beams depending therefrom and adjacent to said sidewalls, said cantilevered beams adapted to operatively engage a portion of a wiper assembly.

2. The wiper coupler as set forth in claim 1 wherein said platform further includes at least two ridges along opposite sides of said rest, said ridges adapted to restrict lateral movement of a portion of a wiper arm operatively received by said rest.

3. The wiper coupler as set forth in claim 1 wherein each of said cantilevered beams further includes a flanged terminal end adapted to facilitate operative engagement of said coupler to a portion of a wiper assembly disposed between said sidewalls and said cantilevered beams.

4. The wiper coupler as set forth in claim 1 wherein said wiper coupler further includes aligned recesses disposed within said subsurface adapted to receive a portion of a wiper assembly and a housing depending from said subsurface, said housing having a passage aligned with said apertures to operatively engage a transversely extending pin of a wiper arm.

5. The wiper coupler as set forth in claim 1 wherein said subsurface further includes at least one leg depending therefrom and adapted to restrict lateral movement of said coupler relative to a wiper assembly.

6. The wiper coupler as set forth in claim 1 wherein said subsurface further includes two opposed legs depending therefrom and adapted to restrict lateral movement of said coupler relative to a wiper assembly.

7. The wiper coupler as set forth in claim 1 wherein said super-surface further includes a groove extending parallel to said rest, said groove adapted to limit the range of movement of a wiper arm during connection to a wiper assembly.

8. The wiper coupler as set forth in claim 1 wherein said sidewalls further include at least one raised surface adapted to provide structural support to said sidewalls.

9. A wiper assembly for use in connection with a wiper arm having a transversely extending pin and a bent tab, said wiper assembly comprising:
a superstructure adapted to facilitate movement of said wiper assembly across a surface to be wiped, said superstructure including a primary lever and at least one secondary lever operatively engaged to said primary lever;
a wiper element operatively supported by said superstructure and adapted to contact the surface to be wiped; and
a wiper coupler operatively engaged to said superstructure and adapted to releasably couple a wiper arm to said superstructure, said wiper coupler including a pair of sidewalls with each sidewall including an aperture aligned with respect to the other, each aperture adapted to operatively receive a transversely extending pin of a wiper arm, a platform disposed between said sidewalls having a super-surface and a subsurface, said super-surface including a rest portion adapted to operatively receive a portion of a wiper arm, said subsurface including a pair of cantilevered beams depending therefrom and adjacent to said sidewalls, said cantilevered beams adapted to operatively engage a portion of said superstructure.

10. The wiper assembly as set forth in claim 9 wherein each of said cantilevered beams further includes a flanged terminal end adapted to facilitate operative engagement of a portion of said primary lever disposed between said sidewalls and said cantilevered beams.

11. The wiper assembly as set forth in claim 10 wherein said primary lever further includes a pair of aligned notches to operatively receive said flanged terminal ends of said cantilevered beams.

12. The wiper assembly as set forth in claim 9 wherein said primary lever includes a pair of aligned shoulders to facilitate operative engagement of said superstructure to said wiper coupler.

13. The wiper assembly as set forth in claim 12 wherein said coupler further includes aligned recesses disposed on said subsurface to operatively receive said aligned shoulders and restrict lateral movement between said superstructure and said wiper coupler.

14. The wiper assembly as set forth in claim 9 wherein said platform of said wiper coupler further includes at least two ridges along opposite sides of said rest, said ridges adapted to restrict lateral movement of a portion of a wiper arm operatively received by said rest.

15. The wiper assembly as set forth in claim 9 wherein said wiper coupler further includes a housing depending from said subsurface, said housing having a passage aligned with said apertures to operatively engage a transversely extending pin of a wiper arm.

16. The wiper assembly as set forth in claim 9 further includes at least one leg depending from said subsurface and adapted to restrict lateral movement of said coupler relative to a wiper assembly.

17. The wiper assembly as set forth in claim 16 wherein said primary lever includes at least one bay to operatively receive said leg, wherein the number of said bays corresponds to the number of said legs.

18. The wiper assembly as set forth in claim 9 wherein said wiper coupler further includes a groove on said super-surface extending parallel to said rest, said groove adapted to limit the range of movement of a wiper arm during connection to said wiper assembly.

19. The wiper assembly as set forth in claim 9 wherein said primary lever includes bores aligned with respect to each other and with respect to said sidewall apertures to operatively receive a portion of a wiper arm.

20. The wiper assembly as set forth in claim 9 wherein said wiper element is removably secured to said superstructure.

21. A wiper system for use in connection with wiping a vehicle substrate, said wiper system comprising:
a wiper arm adapted to move across a surface to be wiped, said wiper arm including a pin extending transversely from said arm and a bent tab extending transversely from said arm adjacent said pin; and
a wiper assembly including a super structure and a wiper element operatively supported by said superstructure and adapted to contact the surface to be wiped, said superstructure having a primary lever and at least one secondary lever operatively supported by said primary lever, said super structure adapted to facilitate reciprocal movement of said wiper assembly across a surface to be wiped,
wherein said wiper assembly further includes a wiper coupler operatively engaged to said superstructure and adapted to releasably connect said wiper arm to said superstructure, said wiper coupler including a pair of sidewalls with each sidewall including an aperture aligned with respect to the other, each aperture adapted to operatively receive said transversely extending pin of said wiper arm, a platform disposed between said sidewalls having a super-surface and a subsurface, said super-surface including a rest portion adapted to operatively receive a portion of said bent tab of said wiper arm and said subsurface including a pair of cantilevered beams depending therefrom and adjacent to said sidewalls, said cantilevered beams adapted to operatively engage a portion of said superstructure.

22. The wiper system as set forth in claim 21 wherein each of said cantilevered beams further includes a flanged terminal end adapted to facilitate operative engagement of a portion of said primary lever disposed between said sidewalls and said cantilevered beams.

23. The wiper system as set forth in claim 22 wherein said primary lever further includes a pair of aligned notches to operatively receive said flanged terminal ends of said cantilevered beams.

24. The wiper system as set forth in claim 21 wherein said primary lever further includes a pair of aligned shoulders to facilitate operative engagement of said superstructure to said wiper coupler.

25. The wiper system as set forth in claim 24 wherein said wiper coupler further includes aligned recesses disposed on said subsurface to operatively receive said aligned shoulders, said shoulders and said recesses adapted to cooperatively restrict lateral movement between said superstructure and said wiper coupler.

26. The wiper system as set forth in claim 21 wherein said platform of said wiper coupler further includes at least two ridges along opposite sides of said rest, said ridges adapted to restrict lateral movement of a portion of a wiper arm operatively received by said rest.

27. The wiper system as set forth in claim 21 wherein said wiper coupler further includes a housing depending from said subsurface, said housing having a passage aligned with said apertures to operatively engage a transversely extending pin of a wiper arm.

28. The wiper system as set forth in claim 21 wherein said wiper coupler further includes at least one leg depending from said subsurface and adapted to restrict lateral movement of said coupler relative to said superstructure.

29. The wiper system as set forth in claim 28 wherein said primary lever includes at least one bay to operatively receive said leg, wherein the number of said bays corresponds to the number of said legs.

30. The wiper system as set forth in claim 21 wherein said wiper coupler further includes a groove on said super-surface extending parallel to said rest, said groove adapted to limit the range of movement of said bent tab during connection to said wiper assembly.

31. The wiper system as set forth in claim 21 wherein said primary lever includes bores aligned with respect to each other and with respect to said sidewall apertures to operatively receive a portion of said transversely extending pin.

32. The wiper assembly as set forth in claim 21 wherein said wiper element is removably secured to said superstructure.
